(19) United States
(12) Patent Application Publication
(10) Pub. No.: US 2012/0254356 A1
(43) Pub. Date: Oct. 4, 2012

(54) INFORMATION PROCESSING APPARATUS, INFORMATION PROCESSING METHOD, AND PROGRAM

(76) Inventor: Akifumi KASHIWAGI, Tokyo (JP)

(21) Appl. No.: 13/428,837

(22) Filed: Mar. 23, 2012

(30) Foreign Application Priority Data
Mar. 31, 2011 (JP) 2011-078312

(51) Int. Cl. G06F 15/16

(52) U.S. Cl. 709/217

(57) ABSTRACT

There is provided an information processing apparatus including a reception section which receives unique identification information which is identification information uniquely assigned to a first communication device, and user information regarding a user using the first communication device, from the first communication device, and a client information providing section which transmits client information in which the unique identification information and the user information received by the reception section are associated with each other, to a second communication device.

### BACKGROUND

The present disclosure relates to an information processing apparatus, an information processing method, and a program.

JP 2002-259612A discloses technology for providing a user viewing an exhibition facility with information corresponding to user information (age, purpose of use, and the like). In the technology disclosed in JP 2002-259612A, first, the user registers the user information into a mobile terminal. Then, the user views the exhibition facility in the state of carrying the mobile terminal. When the user arrives at a viewing point of a showpiece, fixed transmission/reception means set at the viewing point transmits identification information for identifying the showpiece to the mobile terminal. The mobile terminal provides the user with showpiece data corresponding to the identification information and the user information from among pieces of showpiece data stored in advance in the mobile terminal.

### SUMMARY

However, in the technology disclosed in JP 2002-259612A, since the user uses a common mobile terminal prepared in advance by the exhibition facility, it is not taken into consideration as to what sort of mobile terminal the user carries. Accordingly, it was difficult for the technology disclosed in JP 2002-259612A to effectively use the user information. In light of the foregoing, it is desirable to provide technology capable of using the user information more effectively.

According to an embodiment of the present disclosure, there is provided an information processing apparatus which includes a reception section which receives unique identification information which is identification information uniquely assigned to a first communication device, and user information regarding a user using the first communication device, from the first communication device, and a client information providing section which transmits client information in which the unique identification information and the user information received by the reception section are associated with each other, to a second communication device.

According to another embodiment of the present disclosure, there is provided an information processing apparatus which includes a reception section which receives, from a second communication device which is capable of communicating with a first communication device and capable of playing back content, client information in which unique identification information which is identification information uniquely assigned to the first communication device and user information regarding a user using the first communication device are associated with each other, a content providing section which transmits the content to the second communication device, and a content information providing section which, in a case where the reception section receives the client information, transmits content information regarding the content to the second communication device.

According to the embodiments of the present disclosure, since the information processing apparatus transmits the client information in which the unique identification information and the user information are associated with each other, the second communication device can acquire the client information.

According to the embodiments of the present disclosure, the information processing apparatus can acquire the client information in which the unique identification information and the user information are associated with each other. Further, in the case where the information processing apparatus acquires the client information, the information processing apparatus transmits the content information to the second communication device, and hence, the second communication device can acquire the content information.

According to the embodiments of the present disclosure described above, since the second communication device can acquire the client information in which the unique identification information and the user information are associated with each other, it becomes possible to perform the processing corresponding to the unique identification information and the user information.

In the same manner, according to the embodiments of the present disclosure, since the information processing apparatus can acquire the client information from the second communication device, it becomes possible to perform the processing corresponding to the unique identification information and the user information.

Therefore, according to the embodiments of the present disclosure, the user information can be used more effectively than in the past.

### BRIEF DESCRIPTION OF THE DRAWINGS

FIG. 1 is an explanatory diagram illustrating a promotion activity;

FIG. 2 is a block diagram showing a configuration of a content providing system according to a first embodiment of the present disclosure;

FIG. 3 is a block diagram showing a configuration of a user terminal;

FIG. 4 is a block diagram showing a configuration of a provider playback device;

FIG. 5 is a block diagram showing a configuration of a content providing device;

FIG. 6 is a block diagram showing a configuration of a user playback device;

FIG. 7 is an explanatory diagram showing an example of an image displayed on a display section of the user terminal;

FIG. 8 is an explanatory diagram showing an example of the image displayed on the display section of the user terminal;

FIG. 9 is an explanatory diagram showing an example of the image displayed on the display section of the user terminal;

FIG. 10 is an explanatory diagram showing an example of the image displayed on the display section of the user terminal;

FIG. 11 is an explanatory diagram showing an example of the image displayed on the display section of the user terminal;

FIG. 12 is an explanatory diagram showing a configuration of a table stored in the provider playback device;

FIG. 13 is an explanatory diagram showing a configuration of a table stored in the content providing device;

FIG. 14 is a sequence diagram showing a procedure of processing performed by the content providing system;

FIG. 15 is a sequence diagram showing a procedure of processing performed by the content providing system;

FIG. 16 is an explanatory diagram illustrating a content providing system-utilization method; and

FIG. 17 is an explanatory diagram illustrating a content providing system-utilization method.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. About promotion activity

2. Configuration of content providing system

3. Procedure of processing performed by content providing system

<1. About Promotion Activity>

In a process of studying a promotion activity, the inventors have achieved the technology according to the embodiments of the present disclosure. Accordingly, the promotion activity will be described.

On the streets, for the purpose of sales promotion, various pieces of content are broadcasted including a latest music and a promotion video of a famous artist. The reasons why the broadcast is carried out on a street are that the street is a place where many people gather, and that it is easy to appeal to eyes and ears of an unspecified number of consumers. As for the former reason, with increase in the absolute number of people watching and listening to the content, the degree of recognition and purchase expectation increase, and therefore, the sales promotion activity naturally has great effects. As for the latter reason, the contents can be distributed not only to the eyes and ears of people who are interested in the content to start with but also to the eyes and ears of people who are not interested up to then by means of environmental sound or video using a large-size display, and therefore, it is effective in that a potential consumer group can be ensured. On the other hand, in the promotion activities on the streets, there are events such as a noise event, a timing event, an approach event, and a feedback event.

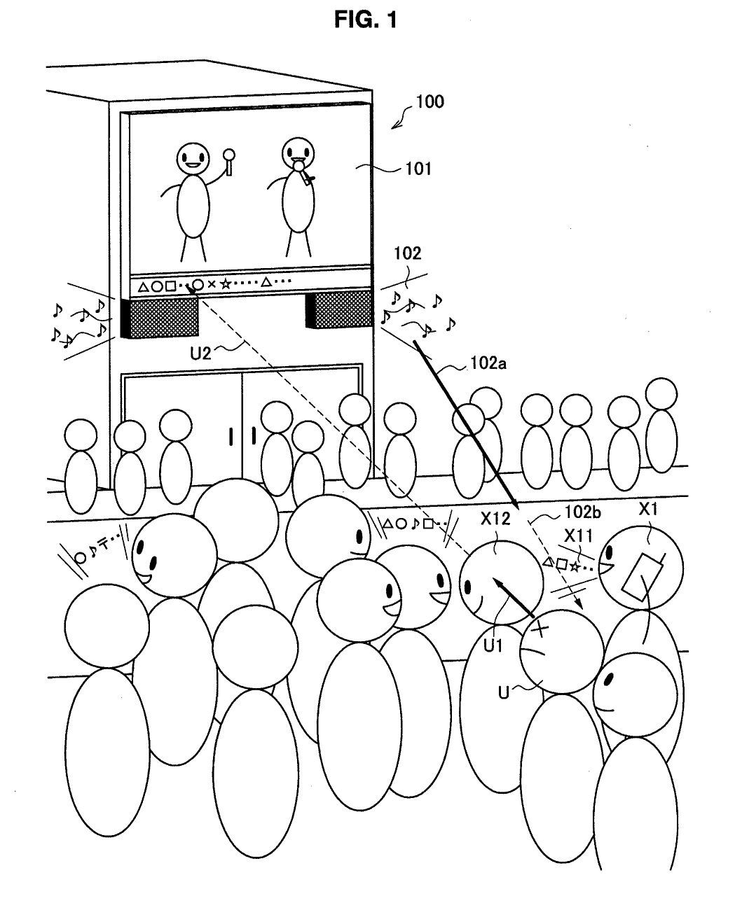

The noise event represents an event that an ambient environment disturbs user's viewing of content, which is caused by the fact that the place at which the user is viewing the content is a street. That is, with increase in the number of people gathering in one place, the value of the place as the place for a sales promotion activity increases. However, at the same time, the degree of viewing-disturbance caused by noise and blockage of the field of view also increases. FIG. 1 shows this state. In FIG. 1, a playback device 100 outputs an image 101 and a sound 102 for a promotion, and a user U directs his/her attention to the image 101 and the sound 102. A part 102a of the sound 102 is output to the user U. However, the sound 102a that is supposed to reach the user U is disturbed by a voice X11 of a passerby X1 who is happened to be at the place. The disturbed sound 102a is shown using an arrow 102b. Thus, the user U cannot catch the sound 102 accurately. Note that the degree of difficulty in catching the sound 102 also depends on the volume/quality of sound of a speaker.

Further, a line of sight U1 of the user U is supposed to reach the image 101, but is blocked by the head of a passerby X12 who is happened to be at the place, and does not reach the image 101. The line of sight U1 blocked by the passerby X12 is shown using an arrow U2. Thus, the user U cannot visually recognize the image 101 accurately. Therefore, there is a possibility that the user U fails to view the content. Note that the degree of difficulty in watching the image 101 also depends on the direction/tilt/brightness of a display.

The timing event represents an event that the user cannot view the entire content, which is also caused by the fact that the place at which the user is viewing the content is a street. That is, it is difficult for the user to know when and where certain content is broadcasted. Accordingly, even when the user happens to pass a place where content that draws the user's interest is being played back, in most cases, it is in the middle of playback of the content. Further, since the user only happens to pass the playback place, the user does not have enough time to view the content until the end in many cases. That is, the user cannot view the entire content.

The approach event represents an event that, even though the user views content on the street and the purchase motivation arises, it takes a great amount of time and effort to purchase the content. That is, even though the user views the content on the street, there are many cases where meta-information of the content cannot be grasped due to the noise event, the timing event, or the like. Here, the meta-information is an outline of the content, and if the content is a music piece, for example, the meta-information includes a music name, an artist name, and the like. Accordingly, even though the user goes to a shop to purchase desired content, since the meta-information of the content is insufficient, it takes a great amount of time and effort to find the desired content. There may be considered the way that where the content is kept may be asked to a store clerk, but since the meta-information is insufficient, it is not easy for the store clerk to grasp the idea of the desired content.

As means for the user to purchase the desired content, there is given the Internet, but also in this case, since the meta-information is insufficient, the same event occurs. For example, it takes a great amount of time and effort to find the desired content, because the user cannot execute keyword search accurately.

The feedback event represents an event that it is difficult for a content provider to give feedback of the result of promotion activity to the promotion activity plan thereafter. For example, even though content is played back by each of multiple playback devices, the installation locations of which are different from one another, and thereby increasing the sales of the content, the content provider cannot determine to what extent the promotion activity (playback of content) performed by each of the playback devices contributes to the sales. Note that there is suggested technology involving causing the playback device to be equipped with a shooting device, and causing the shooting device to shoot a face of a user who watches the playback device, but since the technology can only acquires face information of the user, the user information cannot be sufficiently acquired.

The content providing system according to the embodiments of the present disclosure can reduce the possibility that the above events occur.

<2. Configuration of Content Providing System>

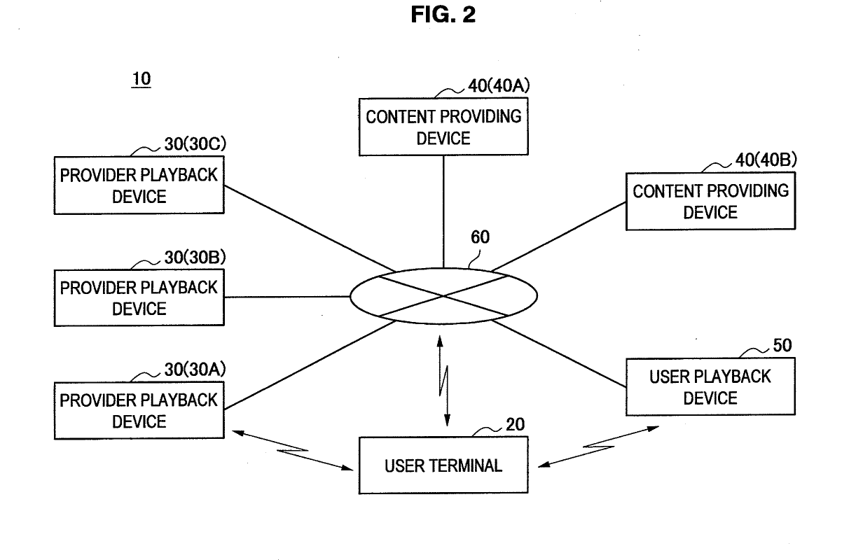

Next, based on FIG. 2 and the like, a content providing system 1 according to the embodiments of the present disclosure will be described. As shown in FIG. 2, the content providing system 1 includes a user terminal 20 (first communication device), a provider playback device 30 (information processing apparatus, second communication device), a content providing device 40 (second communication device, information processing apparatus), a user playback device 50, and a network 60. The user terminal 20, the provider playback device 30, the content providing device 40, and the user playback device 50 are connected to one another via the network 60, and are capable of recognizing one another. Note that the numbers of the respective structural elements, that is, the number of the provider playback devices 30 and the number of the content providing devices 40, for example, are not limited to the numbers shown in FIG. 2. Further, the user terminal 20 is capable of performing direct radio communication with the provider playback device 30, the content providing device 40, and the user playback device 50. The radio communication is performed in accordance with a protocol of radio communication defined by the WiFi Alliance, for example, and the communication via the network 60 is performed in accordance with a protocol defined by the Digital Living Network Alliance, for example.

[2-1. Configuration of User Terminal]

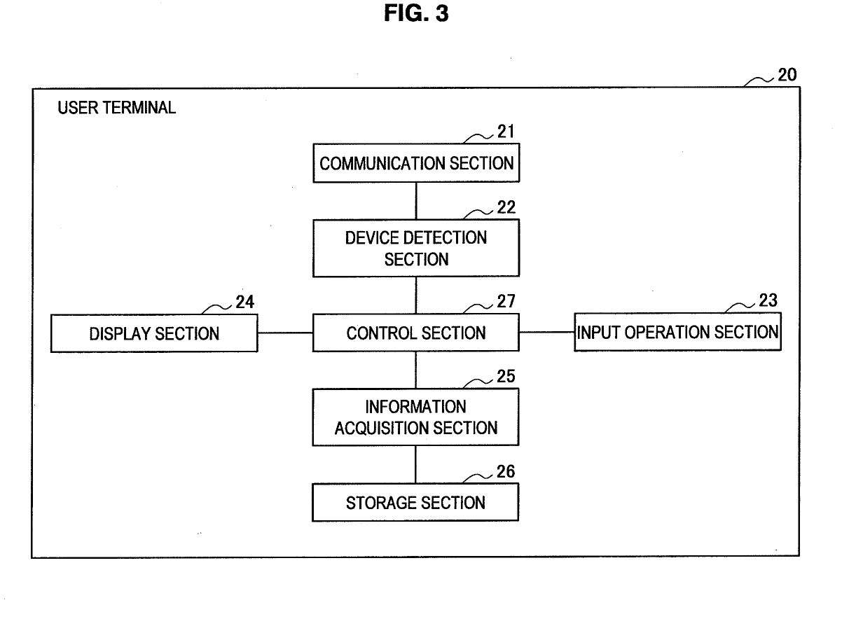

The user terminal 20 includes, as shown in FIG. 3, a communication section 21, a device detection section 22, an input operation section 23, a display section 24, an information acquisition section 25, a storage section 26, and a control section 27. The communication section 21 is capable of performing direct radio communication with the provider playback device 30, the content providing device 40, and the user playback device 50. Further, the communication section 21 is also capable of communicating, via the network 60, with the provider playback device 30, the content providing device 40, and the user playback device 50. Further, the communication section 21 receives a GPS signal from a GPS satellite, and outputs GPS information included in the GPS signal to the device detection section 22. Note that, in the present embodiment, although the user terminal 20 detects the position thereof using the GPS signals, the user terminal 20 may detect the position by another method involving using signals of base stations, for example. Further, the user terminal 20 includes a car navigation device in addition to various types of mobile terminals such as a mobile phone, a mobile tablet PC, a smartphone, and a notebook PC.

The device detection section 22 specifies the current position of the user terminal 20 based on the GPS information, and outputs current position information regarding the specified current position to the control section 27. Further, the device detection section 22 acquires unique identification information (UDN (Unique Device Name), for example, MAC address), which is identification information uniquely assigned to the user terminal 20, from the storage section 26, and outputs the unique identification information to the communication section 21. The unique identification information is uniquely allocated for each user terminal 20, and the pieces of unique identification information differ from one user terminal 20 to another. The communication section 21 generates a search signal including the unique identification information, and transmits the search signal to the periphery of the user terminal 20. A provider playback device 30 present in the periphery of the user terminal 20 sends back, in the case of receiving the search signal, a playback device-presence signal to the user terminal 20 as a response to the search signal. Here, the playback device-presence signal represents a signal including unique identification information, address information (for example, IP address) allocated to the user terminal 20, address information of the provider playback device 30, and access date/time information indicating the date/time at which the provider playback device 30 received the search signal.

The communication section 21 measures the reception strength and the reception azimuth of the playback device-presence signal, and outputs measurement result information regarding the measurement results to the device detection section 22. The communication section 21 stores various types of information included in the playback device-presence signal in the storage section 26. The communication section 21 outputs the address information of the provider playback device 30 included in the playback device-presence signal to the device detection section 22. The device detection section 22 specifies a type and a position of a provider playback device 30 present in the periphery of the user terminal 20 based on the measurement result information and the address information of the provider playback device 30, and outputs playback device-position information regarding the specified type and position to the control section 27.

In the case where the communication section 21 is provided with content information request information by the control section 27, the communication section 21 generates a content information request signal including the content information request information, and transmits the content information request signal to the provider playback device 30. Here, the content information request signal includes information that content information is required, the address information of the provider playback device 30 selected by the user, and the address information of the user terminal 20.

The input operation section 23 is a touch panel provided on the surface of the display section 24, and outputs input operation information corresponding to the operation (for example, touching a specific position of the input operation section 23, or moving a finger from the specific position in a specific direction) performed by the user to the control section 27.

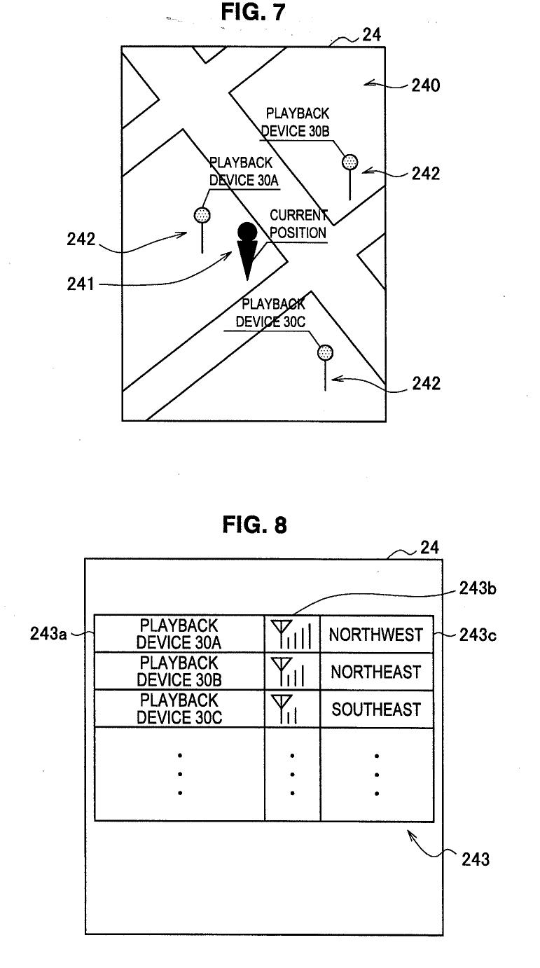

The display section 24 is the so-called display, and displays various types of images. Further, the display section 24 includes a speaker (not shown), and various types of sounds can be output using the speaker. FIGS. 7 to 11 each show an example of the image displayed on the display section 24. FIG. 7 shows an example of a playback device map 240. The playback device map 240 is displayed as a result obtained by the user terminal 20 transmitting the search signal to the periphery thereof and the provider playback device 30 sending back the playback device-presence signal as a response. Drawn in the playback device map 240 are a current position marker 241 indicating the current position of the user terminal 20, a playback device marker 242 indicating the position of the provider playback device 30, and a map around the user terminal 20. Among the displayed playback device markers 242, the user touches the playback device marker 242 corresponding to the provider playback device desired by the user (that is, provider playback device playing back the content that the user wants to view). In this way, the user selects the desired provider playback device 30. Note that certificate information regarding a content provider may be included in the playback device-presence signal, and the certificate information may be displayed on the current position marker 241.

FIG. 8 shows an example of a playback device list 243. The playback device list 243 is displayed as a result obtained by the user terminal 20 transmitting the search signal to the periphery thereof and the provider playback device 30 sending back the playback device-presence signal as a response. That is, the display section 24 displays the playback device map 240 or the playback device list 243 as the result obtained by the user terminal 20 searching for the provider playback device 30. Of course, the display section 24 may display both the playback device map 240 and the playback device list 243, or may display one of them in accordance with the user's designation.

The playback device list 243 includes a playback device name display field 243a in which names of provider playback devices 30 are displayed, a reception strength display field 243b in which reception strengths of the playback device-presence signals are displayed, and a reception azimuth display field 243c in which reception azimuths of the playback device-presence signals are displayed. In the playback device list 243, the user touches the part corresponding to the provider playback device desired by the user. In this way, the user selects the desired provider playback device 30. Note that certificate information regarding a content provider may be included in the playback device-presence signal, and the certificate information may be displayed on the playback device list 243.

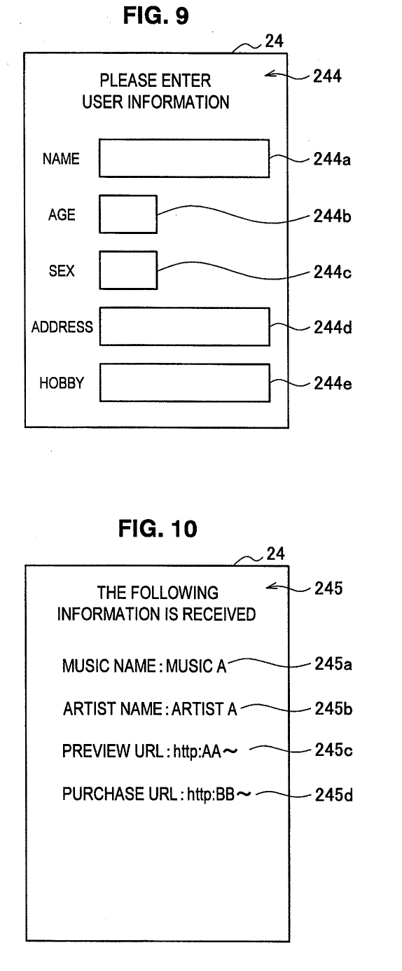

FIG. 9 shows an example of a user information input template 244. The user information input template 244 is displayed in the case where the input of user information is required from the provider playback device 30. In this example, the user information input template 244 includes a name input field 244a, an age input field 244b, a sex input field 244c, an address input field 244d, and a hobby input field 244e. That is, the user information input template 244 has an input field for each attribute (name, age, sex, or the like) of the user information. Of course, the number of input fields displayed on the user information input template 244 may be more than or less than that. The user selects an attribute by touching any one of those input fields. The display section 24 displays a keyboard image (not shown) when any one of the input fields is touched. The user touches the keyboard image, and thus inputs user information. The input user information is stored in the storage section 26, and is also transmitted to the provider playback device 30 as a user information providing signal.

FIG. 10 shows an example of a content information summary image 245. The content information summary image 245 is displayed as a result obtained by transmitting, by the user terminal 20, the user information to the provider playback device 30. The content information summary image 245 is an image for displaying content information. Here, the content information is information regarding content, and includes meta-information of the content. The meta-information represents all pieces of information necessary for specifying the content, and is information such as a title of the content (music name, title, album name, or the like), a name of a person who appears in the content (artist name, actor name, character name, or the like), a name of a content provider (for example, broadcast station name), a classification according to the type of the content (for example, classification into music piece, promotion video of a game, promotion video of a film, and the like), the resolution of the content, and the price of the content. In particular, in the present embodiment, the content information includes a URL indicating the location of the content, and to be specific, includes a URL for a preview and a URL for purchase. In the present embodiment, since the content providing device 40 provides the content for a preview and the content for purchase, those URL's indicate the location of the content providing device 40 (substantially, a storage location within a content information storage device 70). Those URL's are given, for example, in a form of “http://server.IPaddress//(information indicating the location of each content).

In the example shown in FIG. 10, the content information summary image 245 includes a music name display field 245a, an artist name display field 245b, a preview URL display field 245c, and a purchase URL display field 245d. That is, in this example, the content information summary image 245 displays, out of the pieces of content information described above, the music name, the artist name, the preview URL, and the purchase URL.

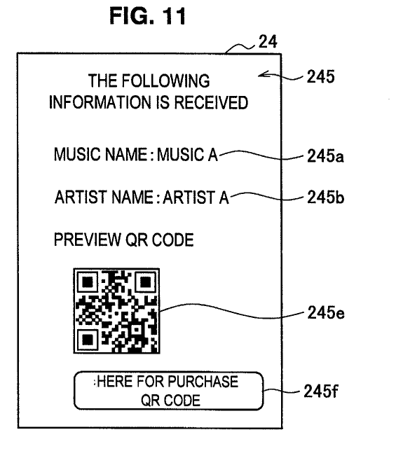

Note that, as shown in FIG. 11, the preview URL and the purchase URL may each be given in a form of a QR code. FIG. 11 shows another example of the content information summary image 245. In the example shown in FIG. 11, there are displayed a preview QR code 245e and a purchase QR code display button 245f in places of the preview URL display field 245c and the purchase URL display field 245d. The user causes a QR code-readable playback device to read the preview QR code 245e, and thus can view the preview content. Further, the user touches the purchase QR code display button 245f, and thus can cause a purchase QR code to be displayed.

The information acquisition section 25 acquires various types of information from the storage section 26, and outputs the information to the control section 27 and the like. The storage section 26 stores therein information necessary for processing performed by the user terminal 20, such as various types of image information, sound information, and programs. The control section 27 controls each of the structural elements included in the user terminal 20, and also performs various types of processing.

[2-2. Configuration of Provider Playback Device]

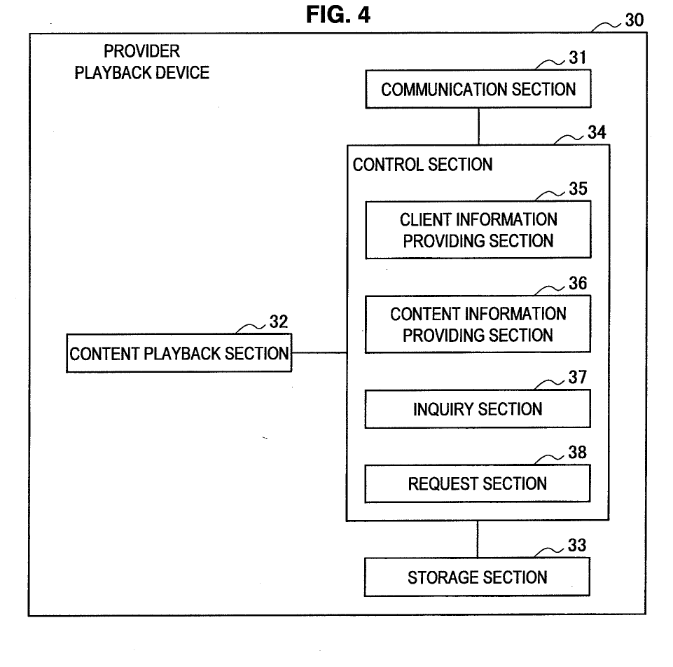

Next, based on FIG. 4, a configuration of the provider playback device 30 will be described. The provider playback device 30 includes a communication section 31, a content playback section 32, a storage section 33, and a control section 34.

The communication section 31 is capable of performing radio communication with the user terminal 20, and is also capable of communicating, via the network 60, with the content providing device 40 and the user playback device 50. Note that the signal transmitted by the communication section 31 includes the address information of the transmission source, that is, the provider playback device 30.

For example, in the case where the communication section 31 receives a search signal transmitted from the user terminal 20, the communication section 31 determines the address information (for example, IP address) of the user terminal 20 based on unique identification information included in the search signal, and causes the storage section 33 to store the address information in association with the unique identification information. Further, the communication section 31 sends back to the user terminal 20 a playback device-presence signal including the address information of the user terminal 20 and the address information of the provider playback device 30.

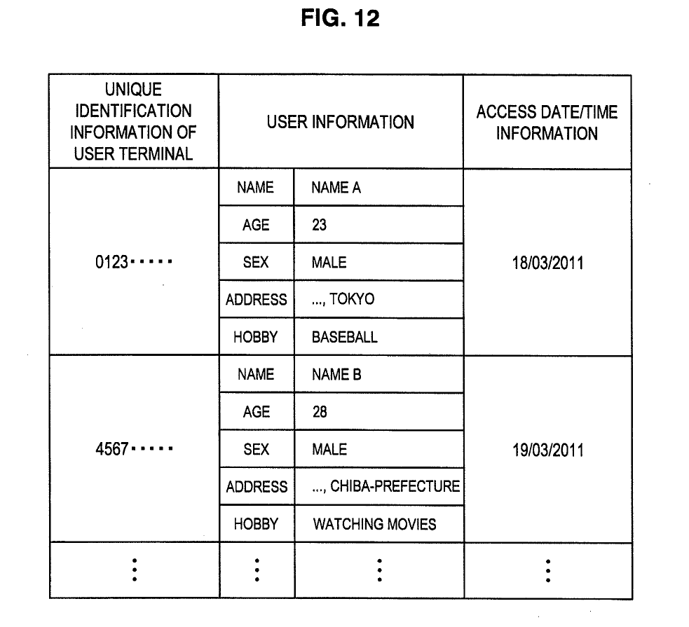

Further, the communication section 31 generates access date/time information regarding the date/time at which the search signal is received. After that, the communication section 31 determines whether the unique identification information and the user information are recorded in an access log management table shown in FIG. 12, and in the case where those pieces of information are already stored, the communication section 31 generates a new row to which the unique identification information and the user information are copied, and stores the access date/time information in the new row. On the other hand, in the case where those pieces of information are not stored, the communication section 31 generates a new row in the access log management table, and records the unique identification information and the access date/time information in an associated manner in the new row.

Further, in the case where the communication section 31 receives a content information request signal transmitted from the user terminal 20, the communication section 31 outputs information included in the content information request signal to the control section 34. The control section 34 generates inquiry information based on the information, and outputs the inquiry information to the communication section 31. Here, the inquiry information includes information that inquires of the content providing device 40 whether the user information is registered, the unique identification information, the latest access date/time information corresponding to the unique identification information, the address information of the content providing device 40 of the inquiry destination, and the address information of the provider playback device 30. In the case where the communication section 31 is provided with the inquiry information by the control section 34, the communication section 31 generates an inquiry signal including the inquiry information, and transmits the inquiry signal to the content providing device 40.

Further, in the case of receiving a content providing signal or a non-registration response signal transmitted from the content providing device 40, the communication section 31 outputs information included in the signal to the control section 34.

Here, in the case where the user information is registered in the content providing device 40, the content providing signal is transmitted as a response to the inquiry signal from the content providing device 40. The content providing signal includes content providing information, that is, content information, unique identification information, address information of the provider playback device 30, and address information of the content providing device 40. The control section 34 generates address information of the user terminal 20 based on the unique identification information, generates content notification information including the content information, the address information of the provider playback device 30, and the address information of the user terminal 20, and outputs the content notification information to the communication section 31. The communication section 31 generates a content notification signal including the content notification information, and transmits the content notification signal to the user terminal 20.

On the other hand, in the case where the user information is not registered in the content providing device 40, the non-registration response signal is transmitted as a response to the inquiry signal from the content providing device 40. The non-registration response signal is a signal including non-registration response information. The non-registration response information includes information that the user information is not registered in the content providing device 40, information indicating an unregistered attribute out of characteristics of the user information, unique identification information, address information of the provider playback device 30, and address information of the content providing device 40. The control section 34 generates user information request information based on those pieces of information, and outputs the user information request information to the communication section 31. Here, the user information request information includes information regarding a requested attribute, that is, information regarding an attribute which is not recorded in the access log management table, out of the unregistered attribute, the address information of the user terminal 20, and the address information of the provider playback device 30. In the case where the communication section 31 is provided with the user information request information by the control section 34, the communication section 31 generates a user information request signal including the user information request information, and outputs the user information request signal to the user terminal 20.

Further, in the case of receiving a user information providing signal transmitted from the user terminal 20, the communication section 31 outputs user information providing information included in the user information providing signal, to be specific, the user information, the address information of the user terminal 20, and the address information of the provider playback device 30, to the control section 34. The control section 34 generates client information based on those pieces of information, and outputs the client information to the communication section 31. Here, the client information is information including the user information, the unique identification information, the address information of the provider playback device 30, and the address information of the content providing device 40, that is, information in which those pieces of information are associated with one another. In the case where the communication section 31 is provided with the client information by the control section 34, the communication section 31 generates a client information providing signal including those pieces of information, and transmits the client information providing signal to the content providing device 40.

Further, in the case of receiving a content signal transmitted from the content providing device 40, the communication section 31 outputs content included in the content signal to the content playback section 32.

The content playback section 32 plays back the content provided by the communication section 31, that is, the content provided by the content providing device 40. Here, the content is provided in a streaming form, and after the content is played back, the content does not remain in the provider playback device 30.

The storage section 33 stores therein information necessary for processing performed by the provider playback device 30, such as various types of programs. In particular, the storage section 33 stores the access log management table shown in FIG. 12. The access log management table records in association with one another unique identification information of the user terminal 20, user information, and access date/time information. Note that, in FIG. 12, the access log management table records therein name, age, sex, address, and hobby of a user as the user information, but the user information is not limited thereto. Further, the access log management table is classified for each set of unique identification information and user information.

The control section 34 controls each of the structural elements included in the provider playback device 30, and also performs processing as a client information providing section 35, a content information providing section 36, an inquiry section 37, and as a request section 38.

In the case where the client information providing section 35 is provided with the user information providing information by the communication section 31, the client information providing section 35 performs the following processing based on the user information providing information. That is, the client information providing section 35 specifies the unique identification information corresponding to the address information of the user terminal 20, and searches the access log management table for the row corresponding to the specified unique identification information. The client information providing section 35 stores the user information in the retrieved row.

Then, the client information providing section 35 generates client information, and outputs the client information to the communication section 31. Here, the content providing device 40 to be a transmission destination of the client information is the content providing device 40 which transmitted the non-registration response signal, that is, the content providing device 40 which provides the provider playback device 30 with content at date/time indicated by the access date/time information.

In the case where the content information providing section 36 is provided with the content providing information by the communication section 31, the content information providing section 36 specifies, out of the pieces of information included in the content providing information, the address information of the user terminal 20 corresponding to the unique identification information. Then, the content information providing section 36 generates content information notification information including the address information of the user terminal 20 that has been specified, the content information, and the address information of the provider playback device 30, and outputs the content information notification information to the communication section 31.

In the case where the inquiry section 37 is provided with content information request information by the communication section 31, the inquiry section 37 generates, based on the content information request information, inquiry information including information that inquires of the content providing device 40 whether the user information is registered, the unique identification information, the latest access date/time information corresponding to the unique identification information, the address information indicating the location of the content providing device 40 of the inquiry destination, and the address information of the provider playback device 30, and outputs the inquiry information to the communication section 31. The content providing device 40 to be the transmission destination is a content providing device 40 which provides the provider playback device 30 with content at date/time indicated by the access date/time information.

The request section 38 specifies, based on the non-registration response information from the communication section 31, an attribute that is not registered in the content providing device 40 and the unique identification information, that is, the user terminal 20 which is a request destination of the user information. In addition, the request section 38 searches the access log management table for the row corresponding to the unique identification information, and determines an attribute obtained by excluding the attributes which are already recorded in the retrieved rows out of the attributes that are not registered in the content providing device 40, as a requested attribute. After that, the request section 38 generates user information request information, and outputs the user information request information to the communication section 31.

[2-3. Configuration of Content Providing Device]

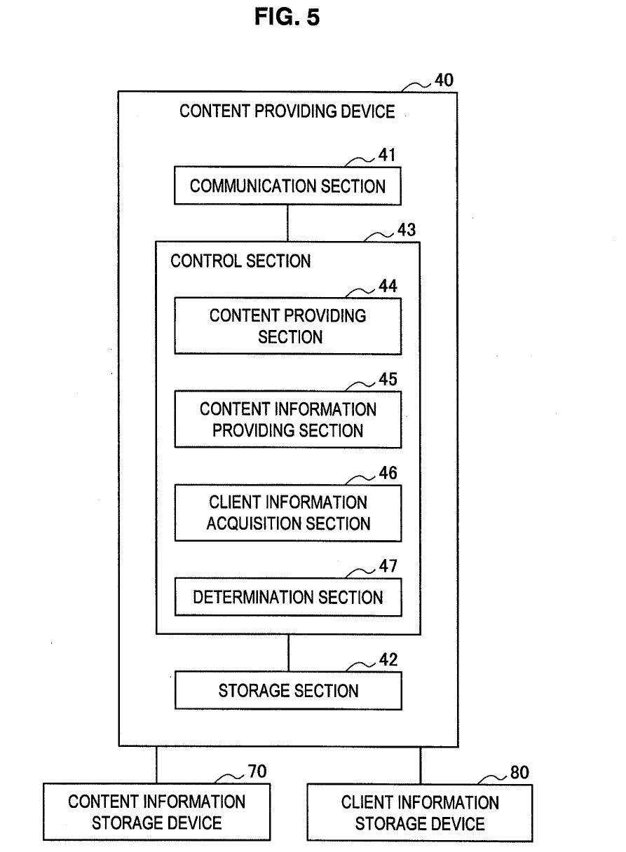

Next, based on FIG. 5, a configuration of the content providing device 40 will be described. The content providing device 40 includes a communication section 41, a storage section 42, and a control section 43, and is connected to a content information storage device 70 and a client information storage device 80.

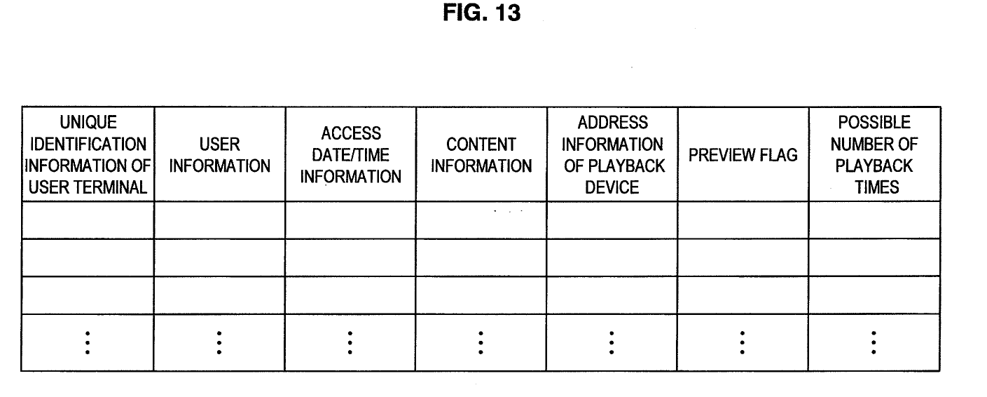

The content information storage device 70 stores various types of content and the content information related thereto in association with each other. Note that as the various types of content, there are prepared the content for a preview and the content for purchase. The preview content may be more restricted than the purchase content. As examples of the restriction, there can be considered that the resolution is lower than that of the purchase content, the sound quality is lower than that of the purchase content, and only a part of the purchase content is recorded. The client information storage device 80 stores a user information management table shown in FIG. 13.

The user information management table records in association with one another unique identification information of the user terminal 20, user information, access date/time information, content information, address information of the provider playback device 30, a preview flag, and possible number of playback times.

An attribute of the user information to be registered in the user information management table is appropriately set by a provider managing the content providing device 40, that is, a content provider. For example, when the content provider managing the content providing device 40A shown in FIG. 2 requires only name, age, and sex as the attributes of the user information, the content provider managing the content providing device 40A causes those attributes to be registered in the user information management table. On the other hand, when the content provider managing the content providing device 40B requires address and hobby in addition to name, age, and sex as the attributes of the user information, the content provider managing the content providing device 40B causes those attributes to be registered in the user information management table. Note that the attributes of user information to be registered in the user information management table may be set such that it varies depending on content to be played back by the provider playback device 30. Further, the user information management table is classified for each set of unique identification information and user information.

The content information to be stored in the user information management table is information regarding the content played back by the provider playback device 30 when the provider playback device 30 receives a search signal (that is, at the time point indicated by the access date/time information). The address information of the provider playback device 30 is the address information of the provider playback device 30 which transmitted the inquiry signal. The preview flag is a flag which indicates whether a preview is permitted to a user, and is represented by a value of “preview available” or “preview unavailable”. The initial value is “preview available”. The possible number of playback times represents the number of times that the user can preview content, and each time the user terminal 20 accesses the content providing device 40 via the user playback device 50, the possible number of playback times decreases by 1, as will be described below. Then, when the possible number of playback times becomes 0, the preview flag is changed to “preview unavailable”.

The communication section 41 is capable of performing radio communication with the user terminal 20, and is also capable of communicating, via the network 60, with the provider playback device 30 and the user playback device 50. For example, in the case where the communication section 41 is provided with the content information, the address information of the provider playback device 30, and the address information of the content providing device 40 by the control section 43, the communication section 41 generates a content signal including those pieces of information, and transmits the content signal to the provider playback device 30.

Further, in the case where the communication section 41 receives an inquiry signal transmitted from the provider playback device 30, the communication section 41 outputs information included in the inquiry signal, that is, inquiry information, to the control section 43. The control section 43 determines whether the user information is registered based on the inquiry information. As a result, in the case where the user information is registered, the control section 43 outputs content providing information including the content information, the unique identification information, the address information of the provider playback device 30, and the address information of the content providing device 40, to the communication section 41. The communication section 41 generates a content providing signal including the content providing information, and transmits the content providing signal to the provider playback device 30. On the other hand, in the case where the user information is not registered, the control section 43 generates non-registration response information including information that the user information is not registered in the content providing device 40, information indicating an unregistered attribute out of characteristics of the user information, unique identification information, the address information of the provider playback device 30, and the address information of the content providing device 40. Then, the control section 43 outputs the non-registration response information to the communication section 41. The communication section 41 generates a non-registration response signal including the non-registration response information, and transmits the non-registration response signal to the provider playback device 30.

Further, in the case where the communication section 41 receives a client information providing signal transmitted from the provider playback device 30, the communication section 41 outputs client information included in the client information providing signal to the control section 43. The control section 43 records the client information in the user information management table.

Further, in the case where the communication section 41 receives a preview request signal from the user playback device 50, the communication section 41 outputs preview request information included in the preview request signal to the control section 43. Here, the preview request information includes information that a preview of content is required, a preview URL, the unique identification information, the user information, the address information of the content providing device 40, and the address information of the user playback device 50. The control section 43 determines whether to permit a preview of content based on the preview request information. In the case of permitting a preview of content, the control section 43 generates preview permission information including preview content, unique identification information, the address information of the user playback device 50, and the address information of the content providing device 40, and outputs the preview permission information to the communication section 41. The communication section 41 generates a preview permission signal including the preview permission information, and transmits the preview permission signal to the user playback device 50.

In the case of not permitting a preview of content, the control section 43 generates preview non-permission information including information that a preview of content is not permitted, the unique identification information, the address information of the user playback device 50, and the address information of the content providing device 40, and outputs the preview non-permission information to the communication section 41. The communication section 41 generates a preview non-permission signal including the preview non-permission information, and transmits the preview non-permission signal to the user playback device 50.

Further, in the case where the communication section 41 receives a purchase request signal transmitted from the user playback device 50, the communication section 41 outputs purchase request information included in the purchase request signal to the control section 43. Here, the purchase request information includes information that purchase of content is required, a purchase URL, the unique identification information, the user information, the address information of the content providing device 40, and the address information of the user playback device 50. The control section 43 generates, based on those pieces of information, purchase procedure information including image information indicating a procedure necessary for the purchase, the unique identification information, the address information of the user playback device 50, and the address information of the content providing device 40, and outputs the purchase procedure information to the communication section 41. The communication section 41 generates a purchase procedure signal including the purchase procedure information, and transmits the purchase procedure signal to the user playback device 50.

Further, in the case where the communication section 41 is provided with purchase procedure completion information by the control section 43, the communication section 41 generates a purchase procedure completion signal including the purchase procedure completion information, and transmits the purchase procedure completion signal to the user playback device 50. Here, the purchase procedure completion information includes information indicating that the procedure necessary for the purchase is completed, the purchase content indicated by the purchase URL, the unique identification information, the address information of the user playback device 50, and the address information of the content providing device 40.

The storage section 42 stores therein information necessary for processing performed by the content providing device 40, such as various types of image information, sound information, and programs.

The control section 43 controls each of the structural elements included in the content providing device 40, and also performs various types of processing as a content providing section 44, a content information providing section 45, a client information acquisition section 46, and as a determination section 47.

The content providing section 44 acquires any one of the pieces of content from the content information storage device 70, and outputs the content to the communication section 41, together with the address information of the provider playback device 30 to which the content is transmitted and the address information of the content providing device 40. Note that the distribution state of content to each of the provider playback devices 30 executed by the content providing section 44 is monitored by the content information providing section 45. That is, the content information providing section 45 monitors the content distributed by the content providing section 44, the provider playback device 30 to which the content is distributed, and the time at which the content is distributed.

Further, in the case where the content providing section 44 is provided with the preview request information by the communication section 41 and is also provided with preview permission determination information by the determination section 47, the content providing section 44 generates preview permission information including content indicated by a preview URL, that is, preview content, the unique identification information, the address information of the user playback device 50, and the address information of the content providing device 40, and outputs the preview permission information to the communication section 41.

On the other hand, in the case where the content providing section 44 is provided with the preview request information by the communication section 41 and is also provided with preview non-permission determination information by the determination section 47, the content providing section 44 generates preview non-permission information including information that a preview of preview content is not permitted, the unique identification information, the address information of the user playback device 50, and the address information of the content providing device 40, and outputs the preview non-permission information to the communication section 41.

Further, in the case where the content providing section 44 is provided with purchase request information by the communication section 41, the content providing section 44 generates purchase procedure information including image information indicating a procedure (for example, purchase procedure using electronic money, FeliCa, and a credit card) necessary for the purchase, the unique identification information, the address information of the user playback device 50, and the address information of the content providing device 40, and outputs the purchase procedure information to the communication section 41.

In the case where receipt of money (for example, receipt of money via a credit card company) from the user is confirmed, the content providing section 44 generates purchase procedure completion information including information indicating that the procedure necessary for the purchase is completed, purchase content indicated by a purchase URL, the unique identification information, the address information of the user playback device 50, and the address information of the content providing device 40, and outputs the purchase procedure completion information to the communication section 41.

In the case where the content information providing section 45 is provided with user information-registered information by the client information acquisition section 46, the content information providing section 45 performs the following processing. Here, the user information-registered information includes information that the user information is registered in the content providing device 40, the unique identification information, the latest access date/time information corresponding to the unique identification information, and the address information of the provider playback device 30. That is, the content information providing section 45 specifies the content that is played back by the provider playback device 30 corresponding to the address information of the provider playback device 30 at the time point corresponding to the access date/time information. Then, the content information providing section 45 acquires content information regarding the specified content from the content information storage device 70, and stores the content information in the row corresponding to the unique identification information, the access date/time information, and the address information of the provider playback device 30 in the user information management table. In addition, the content information providing section 45 generates content providing information including the unique identification information, the content information, the address information of the provider playback device 30, and the address information of the content providing device 40, and outputs the content providing information to the communication section 41.

Further, in the case where the content information providing section 45 is provided with user information non-registration information by the client information acquisition section 46, the content information providing section 45 performs the following processing. Here, the user information non-registration information includes information that the user information is not registered in the content providing device 40, information indicating an unregistered attribute, the unique identification information, the latest access date/time information corresponding to the unique identification information, and the address information of the provider playback device 30. That is, the content information providing section 45 specifies the content that is played back by the provider playback device 30 corresponding to the address information of the provider playback device 30 at the time point corresponding to the access date/time information. Then, the content information providing section 45 acquires content information regarding the specified content from the content information storage device 70, and stores the content information in the row corresponding to the unique identification information, the access date/time information, and the address information of the provider playback device 30 in the user information management table. In addition, the content information providing section 45 generates non-registration response information including the information that the user information is not registered in the content providing device 40, the information indicating an unregistered attribute, the unique identification information, the latest access date/time information corresponding to the unique identification information, the address information of the provider playback device 30, and the address information of the content providing device 40, and outputs the non-registration response information to the communication section 41.

In the case where the client information acquisition section 46 is provided with inquiry information by the communication section 41, the client information acquisition section 46 performs the following processing based on the inquiry information. That is, the client information acquisition section 46 determines whether the user information corresponding to the unique identification information out of the inquiry information is registered in the user information management table.

As a result, in the case where the client information acquisition section 46 determines that the user information is registered in the user information management table, the client information acquisition section 46 generates a new row to which the set of the unique identification information and the user information is copied, and stores, in the generated row, the access date/time information and the address information of the provider playback device 30 which are included in the inquiry information. Then, the client information acquisition section 46 sets the preview flag of the new row to “preview available”, and sets the possible number of playback times to an initial value (for example, 3). After that, the client information acquisition section 46 generates the user information-registered information including the information that the user information is registered in the content providing device 40, the unique identification information, the latest access date/time information corresponding to the unique identification information, and the address information of the provider playback device 30, and outputs the user information-registered information to the content information providing section 45.

On the other hand, in the case where the client information acquisition section 46 determines that the user information is not registered in the user information management table, the client information acquisition section 46 generates a new row in the user information management table, and stores, in the generated row, the inquiry information, that is, the unique identification information, the latest access date/time information corresponding to the unique identification information, and the address information of the provider playback device 30. Then, the client information acquisition section 46 sets the preview flag of the new row to “preview available”, and sets the possible number of playback times to an initial value (for example, 3). After that, the client information acquisition section 46 generates the user information non-registration information including the information that the user information is not registered in the content providing device 40, the information regarding an unregistered attribute, the unique identification information, the latest access date/time information corresponding to the unique identification information, and the address information of the provider playback device 30, and outputs the user information non-registration information to the content information providing section 45.

Further, in the case where the client information acquisition section 46 is provided with client information by the communication section 41, the client information acquisition section 46 searches the user information management table for the row corresponding to the unique identification information out of the client information, and stores the user information in the retrieved row. Then, the client information acquisition section 46 generates the user information-registered information, and outputs the user information-registered information to the content information providing section 45.

In the case where the determination section 47 is provided with the preview request information by the communication section 41, the determination section 47 specifies preview content and content information regarding the preview content, based on the preview URL included in the preview request information. Then, the determination section 47 searches the user information management table for the row corresponding to the unique identification information, the user information, and the content information. As a result, in the case where the determination section 47 could not find the corresponding row, the determination section 47 generates preview non-permission determination information, and outputs the preview non-permission determination information to the content providing section 44. On the other hand, in the case where the determination section 47 could find the corresponding row, the determination section 47 determines whether the preview flag of the retrieved row is set to “preview available”. As a result, in the case where the preview flag is set to “preview unavailable”, the determination section 47 generates the preview non-permission determination information, and outputs the preview non-permission determination information to the content providing section 44. On the other hand, in the case where the preview flag is set to “preview available”, the determination section 47 generates preview permission determination information, outputs the preview permission determination information to the content providing section 44, and decreases the possible number of playback times by 1. In the case where the possible number of playback times becomes 0, the determination section 47 changes the preview flag to “preview unavailable”. In addition, in the case where a single user terminal 20 transmits a content information request signal multiple times at different times to the provider playback device 30 that plays back the same content, multiple rows are generated each having the same unique identification information, user information, and access date/time information with each other, and hence, there is a possibility that the determination section 47 searches the multiple rows. In this case, if any one of the multiple rows is set to “preview available”, the determination section 47 performs the processing described above to that row. On the other hand, if all of the rows are set to “preview unavailable”, the determination section 47 generates the preview non-permission information, and outputs the preview non-permission information to the content providing section 44. Accordingly, the determination section 47 determines whether to permit the user to play back the preview content based on the access state of the user terminal 20 to the content providing device 40.

[2-4. Configuration of User Playback Device]

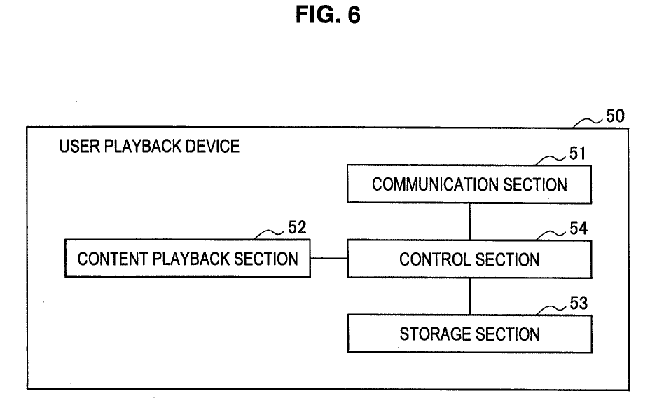

Next, based on FIG. 6, a configuration of the user playback device 50 will be described. The user playback device 50 is a device for playing back content based on instruction issued by a user, and is represented by a display placed in the user's house or a jukebox placed in various facilities, for example.

The user playback device 50 includes a communication section 51, a content playback section 52, a storage section 53, and a control section 54.

The communication section 51 is capable of performing radio communication with the user terminal 20, and is also capable of communicating, via the network 60, with the provider playback device 30 and the content providing device 40. For example, in the case where the communication section 51 is provided with a preview instruction signal by the user terminal 20, the communication section 51 outputs preview instruction information included in the preview instruction signal to the control section 54. Here, the preview instruction information includes information that an instruction of a preview of content is issued, unique identification information, user information, a preview URL, address information of the user terminal 20, and address information of the user playback device 50. The control section 54 generates preview request information based on the preview instruction information, and outputs the preview request information to the communication section 51. The communication section 51 generates a preview request signal including the preview request information provided by the control section 54, and transmits the preview request signal to the content providing device 40.

Further, in the case where the communication section 51 is provided with a purchase instruction signal by the user terminal 20, the communication section 51 outputs purchase instruction information included in the purchase instruction signal to the control section 54. Here, the purchase instruction information includes information that an instruction of purchase of content is issued, the unique identification information, the user information, a purchase URL, the address information of the user terminal 20, and the address information of the user playback device 50. The control section 54 generates purchase request information based on the purchase instruction information, and outputs the purchase request information to the communication section 51. The communication section 51 generates a purchase request signal including the purchase request information provided by the control section 54, and transmits the purchase request signal to the content providing device 40.

Further, the communication section 51 can also read a preview QR code and a purchase QR code. In the case of reading those QR codes, the communication section 51 generates the preview request signal or the purchase request signal based on the read QR code, and transmits the preview request signal or the purchase request signal to the content providing device 40.

Further, in the case where the communication section 51 receives a preview permission signal transmitted from the content providing device 40, the communication section 51 outputs preview permission information included in the preview permission signal to the control section 54. The control section 54 causes the content playback section 52 to play back content, based on the preview permission information.

Further, in the case where the communication section 51 receives a preview non-permission signal transmitted from the content providing device 40, the communication section 51 outputs preview non-permission information included in the preview non-permission signal to the control section 54. The control section 54 causes the content playback section 52 to play back image information that a preview is not permitted, based on the preview non-permission information.

Further, in the case where the communication section 51 receives a purchase procedure signal transmitted from the content providing device 40, the communication section 51 outputs purchase procedure information included in the purchase procedure signal to the control section 54. The control section 54 causes the content playback section 52 to play back image information indicating a purchase procedure, based on the purchase procedure information.

Further, in the case where the communication section 51 receives a purchase procedure completion signal transmitted from the content providing device 40, the communication section 51 outputs information included in the purchase procedure completion signal to the control section 54. The control section 54 causes the content playback section 52 to play back content, based on the purchase procedure completion information.

The content playback section 52 plays back content and the like based on the control performed by the control section 54. The storage section 53 stores therein information necessary for processing performed by the user playback device 50, such as various types of image information and programs. The control section 54 performs various types of processing.

<3. Procedure of Processing Performed by Content Providing System>

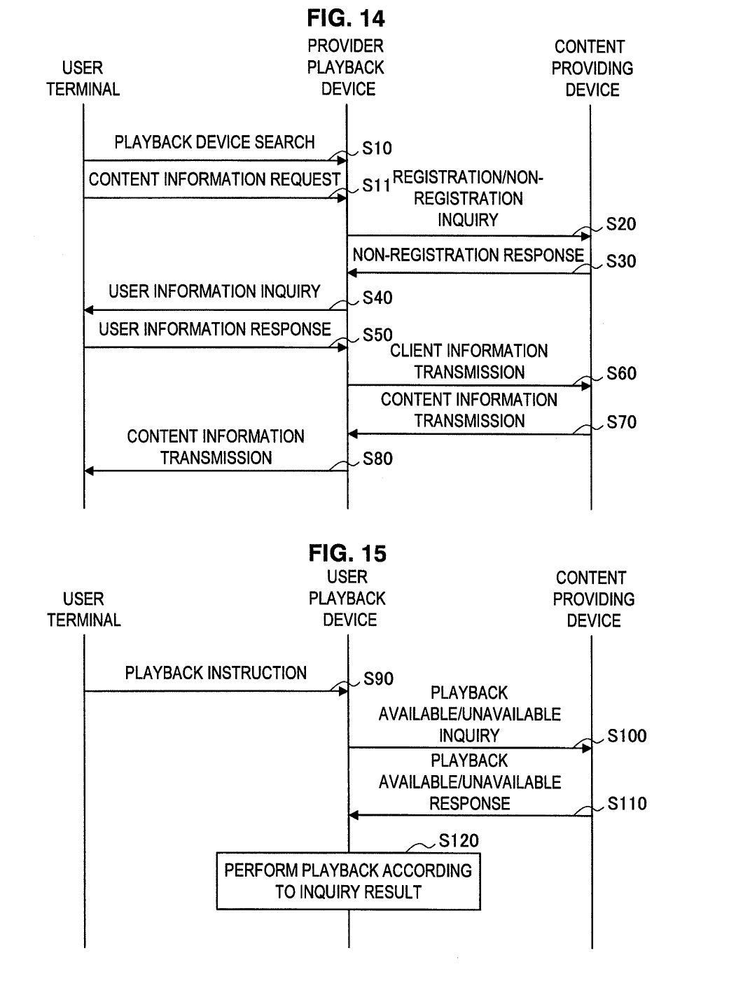

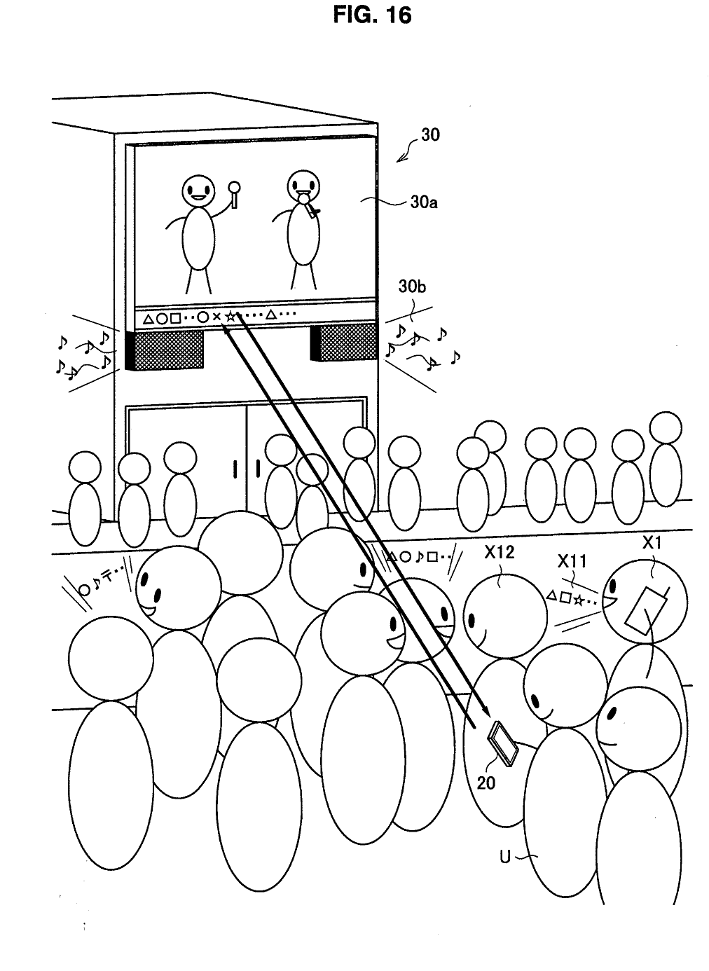

Next, based on sequence diagrams shown in FIG. 14 and FIG. 15, a procedure of processing performed by a content providing system will be described.

As shown in FIG. 16, the provider playback device 30 is playing back content based on a content signal transmitted from the content providing device 40. A user U becomes interested in the content played back by the provider playback device 30, but the visual recognition of an image 30a is disturbed by a passerby X2, and the hearing of a sound 30b is disturbed by a voice X11 of a passerby X1.

Accordingly, the user U operates the input operation section 23, and thus, inputs information that an instruction of transmission of a search signal is issued. Next, in Step S10, the device detection section 22 acquires unique identification information from the storage section 26, and outputs the unique identification information to the communication section 21. The communication section 21 generates a search signal including the unique identification information, and transmits the search signal to the periphery of the user terminal 20.

After that, the provider playback device 30 present in the periphery of the user terminal 20 performs the following processing. That is, the communication section 31 receives the search signal. The communication section 31 determines the address information of the user terminal 20 based on the unique identification information included in the search signal, and causes the storage section 33 to store the address information of the user terminal 20 in association with the unique identification information. Then, the communication section 31 sends back, to the user terminal 20, a playback device-presence signal including the address information of the user terminal 20 and the address information of the provider playback device 30. On the other hand, the communication section 31 generates access date/time information regarding the date/time at which the search signal is received. After that, the communication section 31 determines whether the unique identification information and user information are recorded in the access log management table shown in FIG. 12, and in the case where those pieces of information are already stored, the communication section 31 generates a new row to which the unique identification information and the user information are copied, and stores the access date/time information in the new row. On the other hand, in the case where those pieces of information are not stored, the communication section 31 generates a new row in the access log management table, and records the unique identification information and the access date/time information in an associated manner in the new row.

Next, the communication section 21 receives the playback device-presence signal, measures the reception strength and the reception azimuth of the playback device-presence signal, and outputs, to the device detection section 22, measurement result information regarding the measurement results and the address information of the provider playback device 30 included in the playback device-presence signal. On the other hand, the communication section 21 stores various types of information included in the playback device-presence signal in the storage section 26. Further, the communication section 21 receives a GPS signal from a GPS satellite, and outputs GPS information included in the GPS signal to the device detection section 22. The device detection section 22 specifies the current position of the user terminal 20 based on the GPS information, and outputs current position information regarding the specified current position to the control section 27. In addition, the device detection section 22 specifies a type and a position of a provider playback device 30 present in the periphery of the user terminal 20 based on the measurement result information and the address information of the provider playback device 30, and outputs playback device-position information regarding the specified type and position to the control section 27.

Next, the control section 27 causes the display section 24 to display the playback device map 240 shown in FIG. 7 or the playback device list 243 shown in FIG. 8, based on the playback device-position information. In those examples, the provider playback devices 30A to 30C are present in the periphery of the user terminal 20. The user U selects a desired provider playback device 30 based on the playback device map 240 or the playback device list 243. To be specific, the user U touches a part corresponding to the provider playback device desired by the user among the current position markers 241 or on the playback device list 243.

Next, in Step S11, the control section 27 generates content information request information including information that content information is required, the address information of the provider playback device 30 selected by the user, and the address information of the user terminal 20, and outputs the content information request information to the communication section 21. The communication section 21 generates a content information request signal including the content information request information provided by the control section 27, and transmits the content information request signal to the provider playback device 30.

Next, in Step S20, the communication section 31 receives the content information request signal transmitted from the user terminal 20, and outputs content information request information included in the content information request signal to the inquiry section 37.

The inquiry section 37 generates, based on the content information request information provided by the communication section 31 and the access log management table, inquiry information including information that inquires of the content providing device 40 whether the user information is registered, the unique identification information, the latest access date/time information corresponding to the unique identification information, the address information indicating the location of the content providing device 40 of the inquiry destination, and the address information of the provider playback device 30, and outputs the inquiry information to the communication section 31. The content providing device 40 to be the inquiry destination is a content providing device 40 which provides the provider playback device 30 with content at date/time indicated by the access date/time information.

In Step S30, the communication section 41 receives the inquiry signal transmitted from the provider playback device 30, and outputs information included in the inquiry signal, that is, inquiry information, to the client information acquisition section 46.

Next, in the case where the client information acquisition section 46 is provided with the inquiry information by the communication section 41, the client information acquisition section 46 performs the following processing based on the inquiry information. That is, the client information acquisition section 46 determines whether the user information corresponding to the unique identification information out of the inquiry information is registered in a user information management table.

As a result, in the case where the client information acquisition section 46 determines that the user information is registered in the user information management table, the client information acquisition section 46 generates a new row to which the set of the unique identification information and the user information is copied, and stores, in the generated row, the access date/time information and the address information of the provider playback device 30 which are included in the inquiry information. Then, the client information acquisition section 46 sets the preview flag of the new row to “preview available”, and sets the possible number of playback times to an initial value (for example, 3). After that, the client information acquisition section 46 generates user information-registered information including the information that the user information is registered in the content providing device 40, the unique identification information, the latest access date/time information corresponding to the unique identification information, and the address information of the provider playback device 30, and outputs the user information-registered information to the content information providing section 45. After that, the content providing device 40 proceeds to Step S70.

On the other hand, in the case where the client information acquisition section 46 determines that the user information is not registered in the user information management table, the client information acquisition section 46 generates a new row in the user information management table, and stores, in the generated row, the inquiry information, that is, the unique identification information, the access date/time information, and the address information of the provider playback device 30. Then, the client information acquisition section 46 sets the preview flag of the new row to “preview available”, and sets the possible number of playback times to an initial value (for example, 3). After that, the client information acquisition section 46 generates user information non-registration information including the information that the user information is not registered in the content providing device 40, the information regarding an unregistered attribute, the unique identification information, the latest access date/time information corresponding to the unique identification information, and the address information of the provider playback device 30, and outputs the user information non-registration information to the content information providing section 45.

Next, the content information providing section 45 performs the following processing, based on the user information non-registration information provided by the client information acquisition section 46. That is, the content information providing section 45 specifies the content that is played back by the provider playback device 30 corresponding to the address information of the provider playback device 30 at the time point corresponding to the access date/time information. Then, the content information providing section 45 stores the content information regarding the specified content in the row corresponding to the unique identification information, the access date/time information, and the address information of the provider playback device 30 in the user information management table. In addition, the content information providing section 45 generates non-registration response information including the information that the user information is not registered in the content providing device 40, the information indicating an unregistered attribute, the unique identification information, the latest access date/time information corresponding to the unique identification information, the address information of the provider playback device 30, and the address information of the content providing device 40, and outputs the non-registration response information to the communication section 41. The communication section 41 generates a non-registration response signal including the non-registration response information, and transmits the non-registration response signal to the provider playback device 30.

In Step S40, the communication section 31 receives the non-registration response signal transmitted from the content providing device 40, and outputs the non-registration response information included in the non-registration response signal to the request section 38.

The request section 38 specifies, based on the non-registration response information from the communication section 31, an attribute that is not registered in the content providing device 40 and the user terminal 20 which is a request destination of the user information. After that, the request section 38 determines whether all attributes that are not registered in the content providing device 40 are registered in the row corresponding to the unique identification information in the access log management table. As a result, in the case where the request section 38 determines that all attributes that are not registered in the content providing device 40 are registered in the access log management table, the processing proceeds to Step S60, and in the case where it is determined that there is/are unregistered attribute(s), the request section 38 sets, out of the attribute(s) that is/are not registered in the content providing device 40, an attribute not registered in the access log management table as a requested attribute. Then, the request section 38 generates user information request information, and outputs the user information request information to the communication section 31. The communication section 31 generates a user information request signal including the user information request information, and transmits the user information request signal to the user terminal 20.

The communication section 21 receives the user information request signal, and outputs the user information request information included in the user information request signal to the control section 27. The control section 27 causes the display section 24 to display a user information input template 244 for the user U to input the user information regarding the requested attribute based on the user information request information. Note that, in the example shown in FIG. 9, the requested attributes are name, age, sex, address, and hobby. The user U inputs the user information by referring to the user information input template 244.

In Step S50, the control section 27 generates user information providing information based on the input user information and user information request information, and outputs the user information providing information to the communication section 21. Here, the user information providing information includes the input user information, address information of the provider playback device 30, and address information of the user terminal 20. The communication section 21 generates a user information providing signal including the user information providing information, and transmits the user information providing signal to the provider playback device 30.

Next, the communication section 31 receives the user information providing signal, and outputs the user information providing information included in the user information providing signal to the client information providing section 35. In the case where the client information providing section 35 is provided with the user information providing information by the communication section 31, the client information providing section 35 specifies the unique identification information corresponding to the user information providing information, and searches the access log management table for the row corresponding to the specified unique identification information. The client information providing section 35 stores the user information in the retrieved row.

In Step S60, the client information providing section 35 generates client information, and outputs the client information to the communication section 31. Here, the content providing device 40 to be a transmission destination of the client information is the content providing device 40 which transmitted the non-registration response signal, that is, the content providing device 40 which provides the provider playback device 30 with content at date/time indicated by the access date/time information. The communication section 31 transmits a client information providing signal to the content providing device 40.

The communication section 41 receives the client information providing signal, and outputs the client information included in the client information providing signal to the client information acquisition section 46. In the case where the client information acquisition section 46 is provided with the client information by the communication section 41, the client information acquisition section 46 searches for the row corresponding to the unique identification information out of the client information, and stores the user information in the retrieved row. Then, the client information acquisition section 46 generates the user information-registered information, and outputs the user information-registered information to the content information providing section 45.

In Step S70, the content information providing section 45 performs the following processing based on the user information-registered information provided by the client information acquisition section 46. That is, the content information providing section 45 specifies the content that is played back by the provider playback device 30 corresponding to the address information of the provider playback device 30 at the time point corresponding to the access date/time information. Then, the content information providing section 45 acquires content information regarding the specified content from the content information storage device 70, and stores the content information in the row corresponding to the unique identification information, the access date/time information, and the address information of the provider playback device 30 in the user information management table. In addition, the content information providing section 45 generates content providing information including the unique identification information, the content information, the address information of the provider playback device 30, and the address information of the content providing device 40, and outputs the content providing information to the communication section 41. The communication section 41 generates a content providing signal including the content providing information, and transmits the content providing signal to the provider playback device 30.

In Step S80, the communication section 31 receives the content providing signal, and outputs the content providing information included in the content providing signal to the content information providing section 36. The content information providing section 36 generates the address information of the user terminal 20 corresponding to the unique identification information out of the pieces of information included in the content providing information. Then, the content information providing section 36 generates content notification information including content information, the address information of the provider playback device 30, and the address information of the user terminal 20, and outputs the content notification information to the communication section 31. The communication section 31 generates a content notification signal including the content notification information, and transmits the content notification signal to the user terminal 20.

The communication section 21 receives the content notification signal, and outputs the content notification information included in the content notification signal to the control section 27. The control section 27 causes the display section 24 to display the content information summary image 245 as shown in FIG. 10 based on the content notification information. In addition, the control section 27 causes the storage section 26 to store the content notification information. In this way, the user U can retrieve the content information in his/her own user terminal 20.

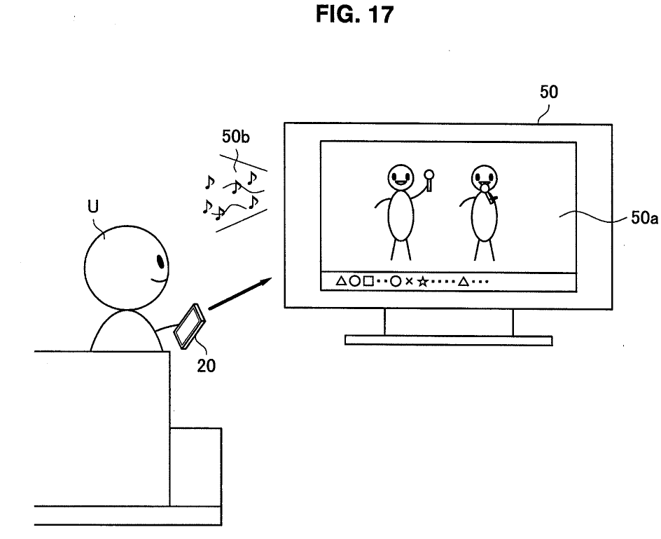

After that, as shown in FIG. 17, the user U causes content to be displayed on the user playback device 50 (that is, display) installed in a living room of a house, for example. First, the user U operates the input operation section 23, and thus, inputs information that the user wants to preview the content.

In Step S90 shown in FIG. 15, the control section 27 generates preview instruction information based on the input information and information stored in the storage section 26, and outputs the preview instruction information to the communication section 21. Here, the preview instruction information includes information that an instruction of a preview of content is issued, unique identification information, user information, a preview URL, address information of the user terminal 20, and address information of the user playback device 50. The communication section 21 generates a preview instruction signal including the preview instruction information, and transmits the preview instruction signal to the user playback device 50.

In Step S100, in the case where the communication section 51 receives the preview instruction signal transmitted from the user terminal 20, the communication section 51 outputs the preview instruction information included in the preview instruction signal to the control section 54. The control section 54 generates preview request information based on the preview instruction information, and outputs the preview request information to the communication section 51. Here, the preview request information includes information that a preview of content is required, a preview URL, the unique identification information, the user information, the address information of the content providing device 40, and the address information of the user playback device 50. The communication section 51 generates a preview request signal including the preview request information, and transmits the preview request signal to the content providing information 40. Note that, in the case where the user U wants to play back content using a QR code-readable user playback device 50 (for example, jukebox), the user U makes the user playback device 50 read a preview QR code. In this way, the user playback device 50 transmits the preview request signal to the content providing information 40.

In Step S110, the communication section 41 receives the preview request signal, and outputs the preview request information included in the preview request signal to the content providing section 44 and to the determination section 47. In the case where the determination section 47 is provided with the preview request information by the communication section 41, the determination section 47 specifies preview content and content information regarding the preview content, based on the preview URL included in the preview request information. Then, the determination section 47 searches the user information management table for the row corresponding to the unique identification information, the user information, and the content information. As a result, in the case where the determination section 47 could not find the corresponding row, the determination section 47 generates preview non-permission determination information, and outputs the preview non-permission determination information to the content providing section 44. Note that, in this case, the content providing device 40 may ask the user to input the user information. On the other hand, in the case where the determination section 47 could find the corresponding row, the determination section 47 determines whether the preview flag of the retrieved row is set to “preview available”. As a result, in the case where the preview flag is set to “preview unavailable”, the determination section 47 generates the preview non-permission determination information, and outputs the preview non-permission determination information to the content providing section 44. On the other hand, in the case where the preview flag is set to “preview available”, the determination section 47 generates preview permission determination information, outputs the preview permission determination information to the content providing section 44, and decreases the possible number of playback times by 1. In the case where the possible number of playback times becomes 0, the determination section 47 changes the preview flag to “preview unavailable”.

In the case where the content providing section 44 is provided with the preview request information by the communication section 41 and is also provided with the preview permission determination information by the determination section 47, the content providing section 44 generates preview permission information including content indicated by a preview URL, that is, preview content, the unique identification information, the address information of the user playback device 50, and the address information of the content providing device 40, and outputs the preview permission information to the communication section 41.

On the other hand, in the case where the content providing section 44 is provided with the preview request information by the communication section 41 and is also provided with the preview non-permission determination information by the determination section 47, the content providing section 44 generates preview non-permission information including information that a preview of preview content is not permitted, the unique identification information, the address information of the user playback device 50, and the address information of the content providing device 40, and outputs the preview non-permission information to the communication section 41.

The communication section 41 generates a preview permission signal including the preview permission information or a preview non-permission signal including the preview non-permission information, and transmits the preview permission signal or the preview non-permission signal to the user playback device 50.

In Step S120, the communication section 51 receives the preview permission signal or the preview non-permission signal, and outputs the information included in the signal to the control section 54. The control section 54 causes the content playback section 52 to play back the information corresponding to the information provided by the communication section 51. For example, the control section 54 causes the content playback section 52 to play back content. In this way, the content playback section 52 outputs an image 50a and a sound 50b, as shown in FIG. 17. Note that a preview of content is performed in a streaming form. That is, after the playback, the preview content does not remain in the user playback device 50. However, the preview content may be left in the user playback device 50, and the user playback device 50 may be set such that the user playback device 50 asks for permission each time the playback is performed.

Note that, in the case where the user U desires to purchase content, a purchase instruction signal is transmitted to the user playback device 50 using the user terminal 20. In response thereto, the user playback device 50 transmits the purchase request signal to the content providing device 40. The content providing device 40 transmits a purchase procedure signal to the user playback device 50, and the user playback device 50 plays back an image indicating a purchase procedure. The user U performs a payment procedure by referring thereto. After that, the content providing device 40 transmits a purchase procedure completion signal to the user playback device 50, and the user playback device 50 plays back the content. Note that the content playback may be performed by the user terminal 20.

In this way, according to the content providing system 1 of the present embodiment, since the content providing device 40 can acquire the client information in which the unique identification information and the user information are associated with each other, it becomes possible to perform processing corresponding to the unique identification information and the user information. For example, the content providing device 40 can permit a preview of content to a user who has registered the unique identification information and the user information. Further, it becomes possible for the content providing device 40 to perform a promotion activity corresponding to the user information and the unique identification information, for example, in the case where a specific user group has a specific type of user terminal 20, an artist who is highly popular among the user group is employed and the promotion activity of advertising a new product of the user terminal 20 can be performed. Accordingly, the content providing device 40 can use the user information more effectively than in the past. In this way, the possibility that the above-mentioned feedback event may occur can be reduced.

In addition, in the case where the provider playback device 30 receives the user information providing signal transmitted from the user terminal 20, the provider playback device 30 transmits a content information notification signal including content information to the user terminal 20, and hence, the user can grasp an outline of the content based on the content information. In this way, the possibility that the approach event may occur is reduced.

Further, the content information with which the user terminal 20 is provided includes the information indicating the location of the content provided by the content providing device 40, that is, the preview URL and the purchase URL, and hence, the user can access the content providing device 40 using those URL's, can preview and purchase content, and can cause the content to be played back by the user playback device 50 desired by the user. In this way, the possibility that the above-mentioned noise event, timing event, and approach event may occur is reduced.

In addition, when receiving the content information request signal from the user terminal 20, the provider playback device 30 transmits, to the content providing device 40, the inquiry signal that inquires of the content providing device 40 whether the user information is registered. Then, in the case of receiving the non-registration response signal, the provider playback device 30 makes a request to the user terminal 20 for the user information. Accordingly, in the case where the user information is not registered in the content providing device 40, that is, only in the case where the user information is necessary, the user inputs the user information, and hence, the time and effort for the user to input the user information are reduced.

In addition, the provider playback device 30 makes a request to the user terminal 20 for the user information regarding an attribute other than the attribute stored in the provider playback device 30, out of the unregistered attribute which is not recorded in the content providing device 40, and hence, the time and effort for the user to input the user information are also reduced.

In addition, the provider playback device 30 transmits information regarding date/time at which the search signal from the user terminal 20 is received, that is, the access date/time information, to the content providing device 40, and hence, the content providing device 40 can grasp the access date/time information. In this way, the content providing device 40 can grasp the promotion activity at which time point is effective, and therefore, the feedback of the promotion activity can be performed to the promotion activity thereafter. For example, in the case where the time period in which a user frequently accesses the provider playback device 30 becomes clear, it becomes possible to take an action such that the promotion activity is carried out concentratedly in that time period. In this way, the possibility that the feedback event may occur is reduced.

In addition, since the provider playback device 30 also transmits its own address information to the content providing device 40, the content providing device 40 can grasp a promotion activity carried out by which provider playback device 30 and at which time point is effective.

In addition, even in the case where the user terminal 20 makes a request to preview the content, since the content providing device 40 limits the number of preview times to a predetermined number of times (initial value of possible number of playback times), unlimited preview by the user can be avoided.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:

a reception section which receives unique identification information which is identification information uniquely assigned to a first communication device, and user information regarding a user using the first communication device, from the first communication device; and

a client information providing section which transmits client information in which the unique identification information and the user information received by the reception section are associated with each other, to a second communication device.

(2) The information processing apparatus according to (1), further including:

a content playback section which plays back content provided by the second communication device; and

a content information providing section which, in a case where the reception section receives the user information transmitted from the first communication device, transmits content information regarding the content to the first communication device.

(3) The information processing apparatus according to (2),

wherein the content information includes address information indicating a location of the content provided by the second communication device.

(4) The information processing apparatus according to any one of (1) to (3), further including:

an inquiry section which, when the reception section receives the unique identification information from the first communication device, inquires of the second communication device whether the user information is registered in the second communication device; and

a request section which, in a case where a response that the user information is not registered in the second communication device is given, makes a request to the first communication device for the user information.

(5) The information processing apparatus according to (4), further including:

a storage section which stores the user information transmitted from the first communication device,

wherein, in a case where information regarding an attribute not registered in the second communication device, out of attributes of the user information, is included in the response from the second communication device, the request section makes a request to the first communication device for the user information regarding an attribute other than an attribute of the user information stored in the storage section, out of the unregistered attribute.

(6) The information processing apparatus according to (4) or (5),

wherein the inquiry section transmits information regarding a time point at which the reception section receives the unique identification information from the first communication device, to the second communication device.

(7) An information processing apparatus including:

a reception section which receives, from a second communication device which is capable of communicating with a first communication device and capable of playing back content, client information in which unique identification information which is identification information uniquely assigned to the first communication device and user information regarding a user using the first communication device are associated with each other;

a content providing section which transmits the content to the second communication device; and

a content information providing section which, in a case where the reception section receives the client information, transmits content information regarding the content to the second communication device.

(8) The information processing apparatus according to (7),

wherein the content information includes address information indicating a location of the content provided by the content providing section, and

wherein, in a case where the first communication device accesses the content, the content providing section transmits the content to a playback device designated by the first communication device.

(9) The information processing apparatus according to (8), further including

a determination section which determines whether to permit the user to play back the content, based on an access state of the first communication device to the content,

wherein, in a case where playback of the content is permitted, the content providing section transmits the content to the playback device designated by the first communication device.

(10) An information processing method including:

receiving unique identification information which is identification information uniquely assigned to a first communication device, and user information regarding a user using the first communication device, from the first communication device; and

transmitting client information in which the received unique identification information and the received user information are associated with each other, to a second communication device.

(11) An information processing method including:

receiving, from a second communication device which is capable of communicating with a first communication device and capable of playing back content, client information in which unique identification information which is identification information uniquely assigned to the first communication device and user information regarding a user using the first communication device are associated with each other;

transmitting the content to the second communication device; and

transmitting, in a case of receiving the client information, content information regarding the content to the second communication device.

(12) A program for causing a computer to realize

a reception function for receiving unique identification information which is identification information uniquely assigned to a first communication device, and user information regarding a user using the first communication device, from the first communication device, and

a client information providing function for transmitting client information in which the unique identification information and the user information received by the reception function are associated with each other, to a second communication device.

(13) A program for causing a computer to realize

a reception function for receiving, from a second communication device which is capable of communicating with a first communication device and capable of playing back content, client information in which unique identification information which is identification information uniquely assigned to the first communication device and user information regarding a user using the first communication device are associated with each other,

a content providing function for transmitting the content to the second communication device, and

a content information providing function for transmitting, in a case where the client information is received by the reception function, content information regarding the content to the second communication device.

The present disclosure contains subject matter related to that disclosed in Japanese Priority Patent Application JP 2011-078312 filed in the Japan Patent Office on Mar. 31, 2011, the entire content of which is hereby incorporated by reference.

What is claimed is:

1. An information processing apparatus comprising:
a reception section which receives unique identification information which is identification information uniquely assigned to a first communication device, and user information regarding a user using the first communication device, from the first communication device; and
a client information providing section which transmits client information in which the unique identification information and the user information received by the reception section are associated with each other, to a second communication device.

2. The information processing apparatus according to claim 1, further comprising:
a content playback section which plays back content provided by the second communication device; and
a content information providing section which, in a case where the reception section receives the user information transmitted from the first communication device, transmits content information regarding the content to the first communication device.

3. The information processing apparatus according to claim 2,
wherein the content information includes address information indicating a location of the content provided by the second communication device.

4. The information processing apparatus according to claim 1, further comprising:
an inquiry section which, when the reception section receives the unique identification information from the first communication device, inquires of the second communication device whether the user information is registered in the second communication device; and
a request section which, in a case where a response that the user information is not registered in the second communication device is given, makes a request to the first communication device for the user information.

5. The information processing apparatus according to claim 4, further comprising:
a storage section which stores the user information transmitted from the first communication device,
wherein, in a case where information regarding an attribute not registered in the second communication device, out of attributes of the user information, is included in the response from the second communication device, the request section makes a request to the first communication device for the user information regarding an attribute other than an attribute of the user information stored in the storage section, out of the unregistered attribute.

6. The information processing apparatus according to claim 4,
wherein the inquiry section transmits information regarding a time point at which the reception section receives the unique identification information from the first communication device, to the second communication device.

7. An information processing apparatus comprising:
a reception section which receives, from a second communication device which is capable of communicating with a first communication device and capable of playing back content, client information in which unique identification information which is identification information uniquely assigned to the first communication device and user information regarding a user using the first communication device are associated with each other;
a content providing section which transmits the content to the second communication device; and
a content information providing section which, in a case where the reception section receives the client information, transmits content information regarding the content to the second communication device.

8. The information processing apparatus according to claim 7,
wherein the content information includes address information indicating a location of the content provided by the content providing section, and
wherein, in a case where the first communication device accesses the content, the content providing section transmits the content to a playback device designated by the first communication device.

9. The information processing apparatus according to claim 8, further comprising
a determination section which determines whether to permit the user to play back the content, based on an access state of the first communication device to the content,
wherein, in a case where playback of the content is permitted, the content providing section transmits the content to the playback device designated by the first communication device.

10. An information processing method comprising:
receiving unique identification information which is identification information uniquely assigned to a first communication device, and user information regarding a user using the first communication device, from the first communication device; and
transmitting client information in which the received unique identification information and the received user information are associated with each other, to a second communication device.

11. An information processing method comprising:
receiving, from a second communication device which is capable of communicating with a first communication device and capable of playing back content, client information in which unique identification information which is identification information uniquely assigned to the first communication device and user information regarding a user using the first communication device are associated with each other;
transmitting the content to the second communication device; and
transmitting, in a case of receiving the client information, content information regarding the content to the second communication device.

12. A program for causing a computer to realize
a reception function for receiving unique identification information which is identification information uniquely assigned to a first communication device, and user information regarding a user using the first communication device, from the first communication device, and
a client information providing function for transmitting client information in which the unique identification information and the user information received by the reception function are associated with each other, to a second communication device.

13. A program for causing a computer to realize
a reception function for receiving, from a second communication device which is capable of communicating with a first communication device and capable of playing back content, client information in which unique identification information which is identification information uniquely assigned to the first communication device and user information regarding a user using the first communication device are associated with each other,
a content providing function for transmitting the content to the second communication device, and
a content information providing function for transmitting, in a case where the client information is received by the reception function, content information regarding the content to the second communication device.
